(19) United States
(12) Patent Application Publication
(10) Pub. No.: US 2008/0103084 A1
(43) Pub. Date: May 1, 2008

(54) MULTIFUNCTIONAL LAUNDRY SHEET

(76) Inventors: Michael J. Banco, Racine, WI (US); Zheng Gu, Tucson, AZ (US)

Correspondence Address: S.C. JOHNSON & SON, INC., 1525 HOWE STREET, RACINE, WI, 53403-2236, US

(21) Appl. No.: 11/924,912

(22) Filed: Oct. 26, 2007

Related U.S. Application Data
(60) Provisional application No. 60/863,152, filed on Oct. 27, 2006.

(51) Int. Cl. C11D 3/60

(52) U.S. Cl. 510/516

(57) ABSTRACT

A multifunctional laundry sheet that comprises, and combines the benefits of, a color catcher, a fabric softener, and a fragrance is disclosed. The color catcher absorbs or traps loose dye in wash liquor during a typical wash cycle of a washing machine, thereby preventing the re-deposition of the dye to fabrics being washed therein, while the fabric softener enhances the appearance of fabrics during a typical drying cycle of an automatic dryer by decreasing static cling, increasing softness and fluffiness, or decreasing wrinkles, of the fabrics. Preferably, at least a portion of the catcher remains associated with the laundry sheet during the washing and imparts visual color change to the laundry sheet after the color catcher is affiliated with loose colorants in the laundry bath. It is also preferable that at least a portion of the fabric softener remains associated with the laundry sheet during the washing process so that the laundry sheet can be further used in a drying process to impart fabric conditioning benefits to the fabrics.

### CROSS-REFERENCE TO RELATED APPLICATION

This application is a non-provisional U.S. application which is based on and claims priority from provisional Application Ser. No. 60/863,152, filed on Oct. 27, 2006.

### BACKGROUND

1. Technical Field

This application relates to a multifunctional laundry sheet that combines the benefits of a color catcher, a fabric softener, and a fragrance in a single fabric care sheet product. The color catcher absorbs or traps loose dye in wash liquor during a typical wash cycle of a washing machine, thereby preventing re-deposition of the dye to fabrics being washed therein, and afterwards, the fabric softener enhances the appearance of fabrics during a typical drying cycle by increasing the softness and fluffiness of the fabrics and decreasing static cling thereof.

2. Description of the Related Art

When fabrics of different colors are laundered, a common problem is encountered where dyes or colorants are released from the fabrics being washed to the wash liquor. Although the colorfastness of the fabrics, the number of times the fabrics have been washed, and conditions under which the fabrics are being laundered are all factors which can influence the amount of dye or colorant released, some amount of dye or colorant invariably becomes detached from its original fabric or substrate. Such extraneous dye or colorant, which may also be referred to as “fugitive dyes,” or “stray dyes,” can be re-deposited on, or associated with, other laundry items of different colors or shades present in the same wash liquor. This “dye transfer” induces undesirable discoloration to fabrics and therefore results in an unsatisfactory appearance for articles being laundered.

Many different types of dyes or colorants have been used to color fabrics. Common fabric dyes include direct dyes used primarily for color cotton and rayon; acid dyes for nylon, wool, and silk; disperse dyes for polyester, nylon, and spandex; azo dyes for cotton, rayon, and silk; reactive dyes for cotton and rayon; and vat dyes used for cotton. Direct, acid and disperse dyes are readily released into wash liquor while azo and vat dyes are not. When properly applied, reactive dyes chemically bond to cellulose and therefore are not readily dissolved; however, if improperly applied, reactive dyes may also be released into the wash liquor. Cotton, nylon, rayon and Spandex fabrics have a strong tendency to associate themselves with dissolved or suspended dyes from solution, while polyester fabrics pick up such dyes to a lesser extent.

During laundry operations, especially during operations involving automatic washing machines, dye transfer occurs mainly during the wash cycle, and very seldom, if at all, during the rinse cycle. Dye transfer occurs during the wash cycle because of higher water temperatures, longer wash times, and higher surfactant concentrations, as compared to less stringent conditions in the rinse cycle.

A number of attempts to solve dye transfer problems have been made which include treating the dyes or colorants so that they have a greater affinity for the dyed material, or eliminating dyes or colorants discharged in the wash water, such as by placing a dye scavenger member in a wash to scavenge and absorb extraneous dyes.

A separate problem typically associated with fabric laundering is the loss of desirable appearance and handling characteristics after a typical drying cycle in an automatic dryer. For example, as a result of static build-up, laundry items tend to stick with each other when taken out of the dryer, and induce a small electric shock when contacted by a user. Consequently, fabric softener additives are used during the laundering process to eliminate static cling and make fabrics soft and fluffy.

Fabric softener is generally used to refer to a composition that introduces a desirable quality to treated fabrics to make them smooth, pliable and fluffy to the touch. Along with imparting softness, it is desirable that the softener composition also reduce the “static cling” of the treated fabrics. Static cling is the phenomenon of one fabric adhering to another, or to parts of itself, as a result of static electrical charges located on the surface of the fabric. Static cling can also involve the adherence of lint, dust and other similarly undesired substances to fabric due to these static charges. Static cling is noticeably present in fabrics which are freshly washed and then dried in an automatic dryer. By softening and reducing the static cling of a fabric, it becomes more comfortable to wear and easier to fold. Fabric softeners may also reduce wrinkles in clothes, thereby reducing the time and effort spent on an ironing process.

Liquid fabrics softeners can be added at the beginning of the laundry cycle at the same time detergent is dispensed or during the rinse cycle. Other fabric softeners can also be manufactured as a sheet to be placed in the dryer.

Numerous compositions have been proposed for incorporation into so called “fabric softeners” used in automatic clothes dryers. Typically, softening agents and anti-static agents are dispensed into the dryer from a suitable substrate on which the anti-static/softening compositions are carried. For example, a highly preferred substrate for use in dispensing the anti-static/softening compositions comprises a sheet of a flexible paper or woven or non-woven cloth on which the compositions have been deposited or impregnated.

Fabric care sheets for either washing or drying cycles are known in the laundry care industry. Such sheets generally include a substrate material, such as a web, wherein the substrate carries one or more ingredients to impart desired benefits to the clothing. Processes for fabricating these laundry sheets are also well known. In a typical process, a large role of a web material is guided at high speeds through various coating, smoothing and drying/cooling steps wherein one or more ingredients are applied to the web.

Most of the laundry sheets disclosed in the art are intended to be used in a dryer for fabric conditioning purposes, and therefore do not include a color catcher to prevent the re-deposition of dyes or colorants on fabrics, as such re-deposition is substantially inhibited in the dryer due to lack of an aqueous medium therein. Similarly, laundry sheets for preventing re-deposition of dyes and colorant on fabrics during the wash cycle are also disclosed in the art.

During a laundering process when the use of both types of aforementioned laundry sheets are preferred, a consumer would have to use two different types of fabric care sheets, one in the wash cycle for preventing dye or colorant re-deposition, and the other in the drying cycle for fabric conditioning, which creates inconvenience and added cost to the consumer. Moreover, a simple yet not uncommon mistake made by a consumer, such as using a wrong type of fabric care sheet in either the washing cycle, or the drying cycle, would potentially damage the fabrics, or result in undesirable appearance and/or handling characteristics of same.

Thus, there is a need for a laundry sheet that combines the functions and benefits of a color catcher and a fabric softener in a single product to obviate the aforementioned inconvenience, as well as to prevent the undesirable results of the aforementioned mistakes.

### SUMMARY OF THE DISCLOSURE

A multifunctional laundry sheet that combines the benefits of a color catcher and a fabric softener in a fabric care product is disclosed.

A laundry sheet that may be used in a washing machine during a typical washing cycle to prevent or inhibit the re-deposition of loose dyes or colorants in wash liquor on fabrics being washed therein is also disclosed.

A laundry sheet that may be used in an automatic dryer during a typical drying cycle to provide fabric conditioning benefits, such as decreasing static cling, increasing softness or fluffiness, and/or reducing wrinkles, of fabrics being dried therein is also disclosed.

In a refinement, a laundry sheet may be used to incorporate a pleasing scent in fabrics during a laundering process, or during the storage of fabrics.

One advantage of some embodiments disclosed herein is to eliminate the inconvenience of using two different laundry sheets in each of the washing cycle and drying cycle of a laundering process.

Further, the disclosed embodiments prevent the undesirable appearance and/or handling characteristics of the fabrics caused by erroneous use of a wrong type of laundry sheet in either the washing cycle or the drying cycle of a laundering process.

One disclosed multifunctional laundry sheet comprises a support matrix, a color catcher for binding, absorbing and/or trapping loose dyes in a laundry bath, and a fabric softener for softening fabrics and decreasing static cling on fabrics, wherein the color catcher and the fabric softener are incorporated in the support matrix. The laundry sheet may further include a fragrance incorporated in the support matrix for imparting a pleasant scent to laundry items during their storage.

In a refinement, the same sheet is used in both a washing process, and a following drying process without any need of an additional sheet or separation from the laundry. Preferably, the colorant binding, absorbing and/or trapping function of the color catcher composition is not adversely affected by the presence of the fabric softener, while the fabric softener functions of the fabric softener is compatible with both the color catcher and commercial detergents that are used in the laundry washing process.

In a second refinement, two substantially identical laundry sheets can be used separately, one for the washing process and the other for the drying process. In the washing process, the sheet functions as a color catcher, and the fabric softener is inactive. In the drying process, however, the sheet functions as a fabric softener without being adversely affected by the color catching composition.

Optionally, the laundry sheet may also be disposed in proximity to fabrics during storage, and the fragrance incorporated therein imparts a fresh, pleasing scent to the fabrics.

The color catcher composition may comprise a functionalized ammonium salt, such as 2-hydroxy-3-halopropyl ammonium salt (HHAS), an epoxy propyl ammonium salt (EPAS), and a mixture thereof, whereas the fabric softener composition may comprise a cationic surfactant, such as a quaternary ammonium salt, that functions as a fabric softener.

The multifunctional laundry sheet may be manufactured in a variety of ways. It may be manufactured by dipping a laundry sheet pretreated with a color catcher into a bath of fabric softening additives, or spraying one side of pretreated sheet with fabric softening additives, or using a formulation containing both a color catcher and a fabric softener to form the multifunctional laundry sheet.

The fabric softening additives should be insoluble in water under typical washing conditions such as 88-92° F. wash cycle, and ambient temperature rinse cycle in order to remain active after the washing process. Moreover, in order to be effective during the drying process, the fabric softener should melt and deposit on fabrics under typical drying conditions, such as 150-170° F. maximum outlet temperature and drying time of 40-50 minutes. When separate, but identical, sheets are used for the wash and dry cycles, however, the relevance of the solubility of the fabric softener is less significant. Therefore, a wide variety of fabrics softeners can be used in the laundry sheet.

The fabric softener preferably does not affect the color catching performance of the laundry sheet, and is preferably inactive toward the prevention of the re-deposition of loose dyes or colorants on fabrics during a typical washing cycle. The color catcher also preferably does not adversely affect the functioning of the fabric softener, such as decreasing static cling, increasing softness or fluffiness, and reducing wrinkle, of the fabrics during a typical drying cycle.

In one preferred embodiment, a portion of the fabric softener initially associated with the support matrix stays attached to the support matrix throughout a washing process. As a result, the laundry sheet used in the washing process can be transferred with the laundry items into a dryer, in which the laundry items are dried through a drying process. It is preferably that, during the drying process, at least a portion of the retained fabric softener is transferred from the laundry sheet to the laundry items during the drying process thereby imparting fabric conditioning benefits to the laundry items.

Other advantages and features of the disclosed methods and compositions will be described in greater detail below. It should be noted that all concentrations discussed hereinafter are based on weight.

### DETAILED DESCRIPTION OF THE PRESENTLY PREFERRED EMBODIMENTS

This disclosure relates to a multifunctional laundry sheet that combines the benefits of a color catcher, a fabric softener, and a fragrance in a single fabric care sheet product. The color catcher binds, absorbs or traps loose dyes or colorants in wash liquor during a typical washing cycle of a washing machine, thereby preventing the re-deposition of the dyes and colorants to fabrics being washed therein, while the fabric softener enhances the appearance of fabrics during a typical drying cycle of an automatic dryer by increasing the softness and fluffiness of the fabrics and decreasing static cling thereof.

One disclosed laundry sheet comprises a color catcher, a fabric softener, and a fragrance, all of which incorporated into a suitable carrier or support matrix.

Therefore, one advantage is that the disclosed sheet addresses the presence of loose dyes or colorants released by fabrics to wash liquor of a washing machine, and essentially prevents the re-deposition of same on other fabrics being laundered therein. A second attribute of disclosed sheets is that they provide a means for discerning that some finite amount of dye transfer has, in fact, taken place within the liquid bath. This is accomplished by having the color catcher impart a visual color change to the support matrix, thereby causing a perceptible visual variation in the “before” and “after” appearance of the laundry sheet. In addition, according to one embodiment, neither the color catcher nor the fabric softener are deleterious to or cause destruction of dyes initially located on the surfaces of the items to be laundered.

The color catcher can be in the form of a stationary color catcher, a mobile color catcher, or a combination thereof, as will be discussed in greater detail below. The stationary color catcher is any substance that has a high affinity for extraneous, free-flowing dyes or colorants in a liquid bath. More particularly, a stationary color catcher is a substance that scavenges dyes from the surrounding bath liquor and is therefore employed for its properties as a “dye take-up” substance. The stationary color catcher also has the ability to impart a color to the underlying support matrix when used in a wash application. A color change in the laundry sheet thus functions as an indicator which provides visible evidence to a user of a disclosed laundry sheet that some color bleeding took place in the wash, and that extraneous dye was scavenged from the wash liquor. The stationary color catcher imparts a color or hue to the laundry sheet by any of a number of possible mechanisms including, but not limited to, adsorbing or absorbing, reacting with, ion pairing, hydrogen bonding, complexation, binding with or otherwise tying up a dye or colorant in or on the support matrix.

The mobile color catcher is a counterpart to the stationary color catcher and performs a complementary function. While the stationary color catcher is initially introduced into the wash liquor by, and remains associated with, the support matrix, the mobile color catcher is any substance which may be found anywhere in the wash liquor and complexes, holds, binds, reacts, ion pairs, hydrogen bonds, reduces the re-deposition affinity of, or otherwise ties up a dye or colorant in the wash liquor. The mobile color catcher is introduced into the wash environment by the support matrix and subsequently becomes dissociated from the support matrix once it is within the wash liquor. This gives rise to a relatively uniform distribution and therefore relatively uniform concentration of the mobile color catcher throughout the wash liquor. By contrast, the stationary color catcher is essentially confined to the locality of the support matrix, and is therefore not uniformly distributed throughout the wash liquor.

The stationary color catcher and mobile color catcher may be of different composition; or preferably, they may be of the same composition but function within different media during the wash process.

The disclosed sheets also address the need of providing fabric conditioning benefits to laundry items during a laundering process. More specifically, the disclosed laundry sheets reduce static cling of fabrics during a typical drying cycle of an automatic dryer, thereby preventing the sticking of one laundry item with another, facilitating the sorting of laundry items after removal from the dryer, and reducing electric shocks to a consumer when contacting the laundry items. Additionally, fabric softener also reduces wrinkles in laundry items, as well as makes laundry items soft and fluffy.

The support matrix fulfills the dual function of delivery system and visual aid. As a delivery system, the support matrix is responsible for introducing the color catcher into the wash liquor of a washing machine. As a visual aid, the support matrix further acts as a substrate upon which the stationary color catcher can impart a color change. A change in color of the matrix is therefore an indication that two processes have taken place: first, that extraneous or fugitive dyes or colorants have arisen from one or more items in the wash; and second, that the stationary color catcher has captured or trapped loose dyes or colorants on the support matrix. In addition, a color change of the support matrix provides subsequent manifestation that re-deposition of loose dyes or colorants has successfully been prevented in the wash liquor due to the presence of the mobile color catcher in the wash liquor and the presence of the stationary color catcher on the support matrix.

Further features of the color catcher, fabric softener, fragrance, and the support matrix will now be addressed individually.

Color Catcher

A color catcher can be in the form of a stationary color catcher, a mobile color catcher, or a mixture of both. The stationary color catcher is introduced into wash liquor by a carrier or support matrix and substantially remains associated with that matrix throughout the washing process. The nature of the relationship by which the stationary color catcher is associated with the support matrix may be characterized by one or more of the following: binding, adsorption or absorption; hydrogen bonding; electrostatic forces such as ion/ion or ion/dipole interactions; intercalation, incorporation or insertion therein; chemical or physical bonding, etc.; or any suitable combination thereof. The stationary color catcher may be introduced into or onto the support matrix by any of a variety of wet or dry techniques which include, but are not limited to, coating, impregnation, spraying, direct chemical reaction, coupling via an intermediary, precipitation, melting, entanglement with the structure, or combinations thereof.

Besides scavenging or absorbing loose dyes or colorants from the wash liquor, an additional function of the stationary color catcher is to impart a color change to the support matrix with which it is associated, and via which it is delivered to the wash liquor according to one disclosed method. The extent of the color change which is associated with the laundry sheet is a function of the composition of the stationary color catcher, the composition of the support matrix, the amounts and types of dyes or colorants in the wash liquor, wash temperature, detergent formulation, and the length of time that the laundry sheet is exposed to the wash liquor.

On the other hand, a mobile color catcher can be any dissolved or dispersed substance which prevents the undesirable discoloration of items in the wash liquor by loose or free flowing dyes or colorants that have been released by items being laundered. The mobile color catcher can achieve this goal by a variety of mechanisms including, but not limited to, suspending the dye in the wash liquor, solubilizing the dye in such a manner that it is unavailable for re-deposition onto a wash item, reducing the affinity of the dye for a textile substrate, trapping the dye, precipitating out the dye, or a combination thereof. Alternately, the mobile color catcher may also adsorb, absorb, or otherwise become associated with any extraneous dyes present in the wash solution in a manner similar to the functioning of the stationary color catcher.

The mobile color catcher is introduced into the wash liquor by the disclosed laundry sheet whereupon it is dissociated from the support matrix, thus losing whatever association it may have initially had with the support matrix. One feature of the support matrix is therefore its ability to function as both a delivery device and a dosing vehicle. Accordingly, the appropriate amount of mobile color catcher can be conveniently added to the laundry bath or wash liquor with each laundering process as a single use item. According to one embodiment, the proportion of mobile color catcher which is delivered to the wash liquor by the support matrix is from about 1 to about 99% of the amount of color catcher initially present in the laundry sheet.

Materials which are suitable as a color catcher for the disclosed laundry sheets include, but are not limited to (quaternary N-substituted ammonium)-hydroxy-haloalkyl salt (HHAS) such as 2-hydroxy-3-chloropropyltrimethylammonium chloride, an epoxy propyl ammonium salt (EPAS) such as epoxy propyl trimethylammonium chloride, polyquaternary ammonium compounds, polyamphoterics, quaternized starches, proteins, chitin or chitosan, choline chloride, polyvinyl amine (PVAm), polyethylene imine (PEI), as well as combinations thereof.

The color catcher is present in an amount of from about 10 g to 200 g, preferably from about 15 g to about 100 g, more preferably from about 15 g to about 25 g per square meter of absorbent substrate. It is to be noted that the color catching efficiency of the color catcher will ultimately determine the amount of a particular color catcher that should be used.

Fabric Softener

There are many types of fabric softeners that can be used which include, but are not limited to, cationic, anionic, nonionic, amphoteric fabric conditioning compounds, or mixtures thereof.

The cationic fabric conditioning compounds used may include a quaternary ammonium salt, which is a dialkyl dimethyl ammonium-chloride or alkyl trimethyl ammonium chloride wherein the alkyl contains from 12 to 20 carbon atoms and are derived from a long chain fatty acids, especially from hydrogenated tallow. The terms “tallow” and “tallowalkyl”, used herein, are intended to mean alkyls containing from 16 to 18 carbon atoms. The term “tallowalkoxy” used herein, means an alkyl ether radical wherein the alkyl contains from 16 to 18 carbon atoms. Those quaternary ammonium salts may include, but are not limited to: didodecyl dimethyl ammonium bromide, ditetradecyl dimethyl ammonium chloride, dipentadecyl dimethyl ammonium chloride, didodecyl diethyl ammonium chloride, ditetradecyl dipropyl ammonium chloride, ditallow dimethyl ammonium chloride, ditallow dimethyl ammonium methyl sulphate, ditallow diethyl ammonium chloride, didodecyl diethyl ammonium chloride, didodecyl diethyl ammonium acetate and ditallow dipropyl ammonium phosphate. Other useful cationic fabric conditioning agents are: dodecyl trimethyl ammonium bromide, tetradecyl trimethyl ammonium chloride, pentadecyl trimethyl ammonium chloride, cetyl trimethyl ammonium bromide, stearyl trimethyl ammonium bromide, tallow trimethyl ammonium chloride, eicosyl trimethyl ammonium chloride, dodecyl trimethyl ammonium methyl sulphate, tallow trimethyl ammonium acetate and tallow dimethyl benzyl ammonium chloride.

The cationic fabric conditioning compounds may also include other cationic nitrogen containing compounds such as substituted immidazolium salt, substituted pyridinium salt, substituted morpholinium salt, and mixtures thereof.

The quaternary ammonium salt and other cationic nitrogen containing compounds may further comprise functional groups including, but not limited to, ether groups, ester groups, epoxy groups, amide groups, carbonyl groups, carboxylic groups, aromatic groups, amino groups, cyano group, and the like.

In the cationic fabric conditioning compounds, an anion, which is any anion compatible to other composition of the laundry sheet, is included in the compounds for providing electrical neutrality. Most often, the anion used to provide electrical neutrality in these salts is from a strong acid, especially a halide, such as chloride, bromide, or iodide. However, other anions can be used, such as methylsulfate, ethylsulfate, acetate, formate, sulfate, carbonate, and the like. In some cases, the anion can also, but less preferably, carry a double charge.

The anionic fabric conditioning compounds used in the present invention may include, but are not limited to, carboxylic acid salts, primary alkyl sulfates, alkyl ether sulfates, fatty acid sulfonates, alkyl benzene sulfonates, sulfosuccinate esters, and organic phosphate esters. Counter ions to the salts of the aforementioned anionic fabric conditioning compounds may be those of alkali metal, alkaline earth metal, ammonium, alkanolammonium, and alkylammonium types.

The nonionic fabric conditioning compounds used may include, but are not limited to, fatty alcohol ethoxylates, alkylphenol ethoxylates, condensates of alkanolamines with fatty acids, polyol fatty acid esters, ethoxylated polyol fatty acid esters, alkylpolyglucosides, and N-alkyl pyrrolidones. The nonionic fabric conditioning compounds may also include nonionic polymers, such as ethylene oxide/propylene oxide block polymers. Furthermore, additional nonionic surfactant not specifically mentioned above, may also be used.

The amphoteric fabric conditioning compounds used may include, but are not limited to, tertiary amine oxide and zwitterionic quaternary ammonium compounds. The tertiary amine oxide compounds useful in the disclosed embodiments preferably have two alkyl groups attached to a nitrogen having at least 8 carbon atoms and no more than 18 carbon atoms, and a third substituent attached to the nitrogen, wherein the third substituent is a lower alkyl group having from 1 to 4 carbon atoms, and preferably is methyl. The preferred amine oxides are, in order, didecyl amine oxide, dinonyl amine oxide, dioctyl amine oxide, didodecyl amine oxide.

The fabric softener is preferably present in an amount of from about 10 g to about 200 g, more preferably from about 20 g to about 150 g, especially about 30 g to about 90 g per square meter of absorbent substrate. It is to be noted that the fabric conditioning performance, such as anti-static, fabric softening, and wrinkle reducing, of the fabric softener will ultimately determine the amount of a particular fabric softener that should be used.

Fragrance

As is well known, a fragrance normally consists of a mixture of a number of fragrant materials, each of which has a particular fragrance. The number of fragrant materials in a fragrance is typically ten or more. The range of fragrant materials used may vary. The materials come from a variety of chemical classes, but in general are water-insoluble oils. In many instances, the molecular weight of a fragrance material is in excess of 150, but does not exceed 300.

The fragrance may be incorporated into the laundry sheet in a variety of ways. It may be formed with the support matrix before the incorporation of either the color catcher or the fabric softener, or it may be incorporated into a laundry sheet that already contains a color catcher and a fabric softener. Preferably, the fragrance is mixed with either the color catcher, or the fabric softener, or a mixture of both, and subsequently incorporated into the support matrix.

The fragrance on a disclosed laundry sheet is preferably present in an amount of from about 0.5% to about 10%, more preferably from about 1% to about 5%, especially about 2% to about 4%, of the weight of the fabric softener on the laundry sheet.

Support Matrix

The color catcher described above is supported on an appropriate vehicle or support matrix. This gives rise to a dual function for the support matrix of the present invention. One feature of the support matrix is that it acts as a conduit for the delivery of the mobile color catcher to a laundry wash liquor. In this regard, the mobile color catcher is associated or affiliated with the support matrix in some appropriate manner such that the mobile color catcher may be delivered from the support matrix to the washing liquor, and subsequently ceases to be associated with the support matrix. A second feature of the support matrix is that it acts as a substrate to which a stationary color catcher is associated at least throughout a substantial portion of a typical washing cycle of a laundry process, during which the support matrix may impart a color to indicate that extraneous dyes have, in fact, been scavenged from the washing liquor and therefore that dye re-deposition on other items in the wash has been avoided. Additionally, the support matrix may be used as a vehicle to deliver other active ingredients such as, but not necessarily limited to, fabric softeners, anti-static agents, and fragrances.

The support matrix which may be used can comprise any type of natural or synthetic material with which a color catcher may become associated, provided that the material used is capable of either delivering the mobile color catcher to the washing liquor, or retaining some association with the stationary color catcher, or both. Further to its function as a carrier for the stationary color catcher, the purpose for the support matrix is to provide a sufficient surface area upon which the stationary color catcher is accessible to wash liquor. Materials which may be suitable for support matrices include both cellulosic and non-cellulosic fibers in both woven and non-woven form. In the case of certain non-woven materials that do not exhibit good wash strength, it may be desirable to use auxiliaries, such as binders, to enhance the durability of the support matrix. Non-woven rayon is one such example of a material with low wash strength which may benefit from the addition of binders.

Preferably, the support matrix comprises substances that have absorptive capacity and/or contain reactive groups due to the ability of the latter to achieve a good visible color indication on the disclosed laundry sheet. Cellulosics such as wood pulp, rayon and cotton are especially effective substances, besides having the additional advantage that they are available at relatively low cost. Synthetic polymeric materials such as polyester, polyethylene and polypropylene may be used as support matrices alone, or in combination with other support matrices as additives to improve fabric wash strength under standard washing conditions. Synthetic polymers are generally regarded as non-reactive towards the incorporation of the color catcher. Other factors that are important in selecting a suitable support matrix include such considerations as durability, hand feel, processability and cost. The laundry sheet should not lint, excessively tear or fall apart during the wash process, nor should it ball up or be heat sensitive to the point of self-destruction during post-washing drying.

Other forms in which the support matrix may be used as will be apparent to those skilled in the art. In one relatively simple embodiment, the support matrix may consist of a fiber or filament. The color catcher, fabric softener, and fragrance may be introduced onto the fiber, which may subsequently be incorporated in woven or non-woven form to generate a sheet. Other forms for the support matrix which are consistent with a disclosed laundry sheet may include such configurations as fiber balls, beads or other forms of intercalation supports in addition to the more conventional sheet form. Ultimately, any item or object that can conveniently be retrieved from a wash load, either after washing or after drying would be appropriate.

Method of Use

In one embodiment, the disclosed laundry sheet is provided in a laundry bath containing at least one laundry item. Preferably, the laundry item includes some colorants that may be dissociated from the laundry item during a typical washing process. The laundry sheet may be deposited in the laundry bath before, after, or simultaneously with, the laundry item.

During the washing process, the loose colorant dissociated from the laundry item is affiliated with the color catcher. As a result, the re-deposition of the loose colorants on the laundry item is substantially prevented. Preferably, the stationary color catcher of the laundry sheet imparts a visual color change to the laundry sheet to indicate dissociation of colorants from the laundry item and the capturing of the colorants by the color catcher.

After the laundry item is washes, the laundry item is transferred into a dryer. In one the embodiment, the same laundry sheet is transferred into the dryer with the laundry item because at least a portion of the fabric softener is retained by the laundry sheet after the washing process. The laundry item is then dried in the dryer, during which a substantial portion of the retained fabric softener provides fabric conditioning benefits to the laundry item. Preferably, the color catcher that remains on the laundry sheet does not adversely affect the performance of the fabric softener.

In another embodiment, a fresh identical laundry sheet is deposited into the dryer with the washed laundry item, which is subsequently dried therein. During the drying process, the fabric softener in the laundry sheet provides fabric conditioning benefits to the laundry item. Preferably, the color catcher of the laundry sheet does not adversely affect the conditioning performance of the fabric softener. In this embodiment, the use of two different laundry sheet in a washing and drying process can be prevented which not only provides convenience to a consumer, but also prevents adverse effects to the laundry when the consumer inadvertently uses a wrong laundry sheet in either the washing or the drying process.

To test the color catching performance of the disclosed laundry sheets a wash test is conducted. A wash sample is provided which includes one red terry cotton towel for providing loose dyes in a washer, one white swatch, as well as a plurality of terry cotton white towels, bed sheets, and t-shirts, wherein the total dry weight of the wash sample is from about 5 to about 6 pounds. The wash sample and a disclosed laundry sheet are washed in a commercial washing machine through a regular wash cycle with medium water level and a commercial liquid detergent. After washing, the colors of the laundry sheet and the white swatch are measured again using the same colorimeter, to generate ΔE measurement for the sheet and the swatch, to evaluate the color catching performance of the laundry sheet, wherein ΔE is defined and calculated according to international standards set forth by International Commission on Illumination (CIE). A higher ΔE for the sheet, or a lower ΔE for the white swatch, or a combination of both, as compared by the ΔEs before and after the laundering process, indicates a greater level of color catching performance of the laundry sheet.

Although the amount of loose dyes or colorants that is captured or trapped by the color catcher will depend on the particular color catcher and support matrix used, it is preferred that the color catcher scavenges enough loose dyes or colorants from the wash liquor such that there is at least a 5%, more preferably 10%, and most preferably 20%, ΔE increase for the laundry sheet after the washing process, while a greater ΔE increase indicates a greater level of color catching performance. An alternate way to evaluate the function of the color catcher is to consider the prevention of dye re-depositing on the white swatch. In one embodiment, the color catcher of the laundry sheet captures or traps enough loose dyes or colorants from the wash liquor such that there is less than a 10%, more preferably 5%, and most preferably 2%, ΔE increase for the white swatch after the washing process, while a smaller ΔE increase indicates a greater level of color catching performance.

To test the fabric softening performance of the disclosed laundry sheet, a dryer test is performed. A drying sample is provided that includes a plurality of terry cotton white towels, cotton/polyester blend bed sheets, t-shirts, as well as a plurality of pieces of 100% nylon, 100% polyester, and 65/35 cotton/polyester blend fabrics, wherein the total dry weight of the drying sample is from about 5 to about 6 pounds. The drying sample is washed through a regular wash cycle with medium water level, and subsequently dried with a disclosed laundry sheet in a commercial automatic drier under medium/permanent press (temperature/fabric) dry cycle for 60 minutes. The anti-static performance of the laundry sheet is evaluated according to typical experiments and/or measurements typically used in the art, while the fabric softening performance of same is based on a panel evaluation, wherein a number of panelist score the softness of a piece of chosen fabric after two parallel drying processes, one with a disclosed laundry sheet, and the other without. In addition, weight change of the sheet before and after the dry cycle is measured to see the effective release of fabric softening ingredients in the dryer.

According to one embodiment, the fabric softener does not contribute to or detract from the color catching performance of the laundry sheet during a typical washing process.

In one preferred embodiment, a portion of the fabric softener initially associated with the support matrix stays attached to the support matrix throughout a washing process. In one embodiment, at least 10%, more preferably at least 20% and most preferably at least 50%, of the fabric softener is retained by the support matrix by the end of the washing process. As a result, the laundry sheet used in the washing process can be transferred with the laundry items into a dryer, in which the laundry items are dried through a drying process. Preferably, at least a portion of the retained fabric softener is transferred from the laundry sheet to the laundry items during the drying process thereby imparting fabric conditioning benefits to the laundry items.

It is preferable that, during the drying process, the fabric softener does not capture or trap any loose dye or colorant during the washing process, and therefore does not induce a significant color change to the laundry sheet. Similarly, a comparison sheet substantially identical to the disclosed laundry sheet but does not include the fabric softener is manufactured and used in a parallel color catching performance test using identical wash samples. As a result, the ΔE increase for the laundry sheet after a laundry process is substantially identical between a test using the comparison sheet and a test using a disclosed laundry sheet.

Alternatively, a substantial portion of the fabric softener initially associated with the support matrix rapidly dissolves in wash liquor during a washing process. The dissolved fabric softener is discharged after the washing process without scavenging any loose dyes or colorants, and therefore does not act to prevent the re-deposition of same on a laundry item. As an example, a comparison sheet substantially identical to the disclosed laundry sheet but does not include the fabric softener is manufactured and used in a parallel color catching performance test using identical wash samples. The ΔE increase of the white swatch after the washing process is substantially identical between a test using the comparison sheet and a test using a disclosed laundry sheet.

While only certain embodiments have been set forth, alternative embodiments and various modifications will be apparent from the above descriptions to those skilled in the art. These and other alternatives are considered equivalents and within the spirit and scope of this disclosure.

What is claimed:

1. A multifunctional laundry sheet comprising:
a support matrix;
a color catcher;
a fabric softener; and
a fragrance,
wherein the color catcher, fabric softener and fragrance are incorporated in the support matrix.

2. The laundry sheet of claim 1 wherein the color catcher has a high binding affinity to loose colorants in a laundry bath.

3. The laundry sheet of claim 1 wherein at least a portion of the fabric softener remains associated with the laundry sheet during a washing process.

4. The laundry sheet of claim 1 wherein the color catcher is selected from the group consisting of functionalized ammonium salts, polyamphoterics, quaternized starches, quarternized proteins, chitin, chitosan, polyvinyl amine, polyethylene imine, and mixtures thereof.

5. The laundry sheet of claim 1 wherein the color catcher is selected from the group consisting of hydroxyl haloalkyl quaternary ammonium salts, epoxy propyl quaternary ammonium salts, polyquaternary ammonium salts, choline chloride, and mixtures thereof.

6. The laundry sheet of claim 1 wherein the color catcher is selected from the group consisting of 2-hydroxy-3-chloropropyl trimethyl ammonium chloride, epoxypropyl trimethyl ammonium chloride, and a mixture of both.

7. The laundry sheet of claim 1 wherein the color catcher is present in an amount of about 10 to about 200 g per square meter of the support matrix.

8. The laundry sheet of claim 1 wherein the fabric softener is selected from the group consisting of cationic, anionic, nonionic, and amphoteric fabric conditioning compounds.

9. The laundry sheet of claim 1 wherein the fabric softener comprises a cationic nitrogen-containing compound selected from the group consisting of quaternary ammonium salts containing a C12-20 alkyl group, substituted immidazolium salts, substituted pyridinium salts, substituted morpholinium salts, and mixtures thereof.

10. The laundry sheet of claim 1 wherein the fabric softener is present in an amount of from about 10 to about 200 g per square meter of the support matrix.

11. The laundry sheet of claim 1 wherein the fragrance is present in an amount of from about 0.5 to about 10% by weight of the fabric softener composition.

12. The laundry sheet of claim 1 wherein the support matrix comprises a fiber material selected from the group consisting of cellulosics, synthetic polymers, and a mixture thereof.

13. A multifunctional laundry sheet comprising:
a support matrix;
a color catcher;
a fabric softener; and
a fragrance,
wherein the color catcher, fabric softener and fragrance are incorporated in the support matrix, and
wherein at least a portion of the color catcher remains associated with the laundry sheet during a washing process and imparts a visual color change to the laundry sheet after the color catcher is affiliated with loose colorants in a laundry bath.

14. The laundry sheet of claim 13 wherein at least a portion of the fabric softener remains associated with the laundry sheet during a washing process.

15. The laundry sheet of claim 13 wherein the color catcher is selected from the group consisting of functionalized ammonium salts, polyamphoterics, quaternized starches, quarternized proteins, chitin, chitosan, polyvinyl amine, polyethylene imine, and mixtures thereof.

16. The laundry sheet of claim 13 wherein the color catcher is selected from the group consisting of 2-hydroxy-3-chloropropyl trimethyl ammonium chloride, epoxypropyl trimethyl ammonium chloride, and a mixture of both.

17. The laundry sheet of claim 13 wherein the color catcher is present in an amount of about 15 to about 25 g per square meter of the support matrix.

18. The laundry sheet of claim 13 wherein the fabric softener comprises a cationic nitrogen-containing compound selected from the group consisting of quaternary ammonium salts containing a C12-20 alkyl group, substituted imidazolium salts, substituted pyridinium salts, substituted morpholinium salts, and mixtures thereof.

19. The laundry sheet of claim 13 wherein the fabric softener is present in an amount of from about 30 to about 90 g per square meter of the support matrix.

20. A method of using a multifunctional laundry sheet in a laundering process comprising:
providing a laundry bath;
providing at least one laundry item in the laundry bath;
depositing a multifunctional laundry sheet in the laundry bath, the laundry sheet comprising a support matrix, and a color catcher and a fabric softener incorporated in the support matrix; and
washing the laundry item in the laundry bath,
wherein at least a portion of the catcher remains associated with the laundry sheet during the washing and imparts visual color change to the laundry sheet after the color catcher is affiliated with loose colorants in the laundry bath, and
wherein at least a portion of the fabric softener remains associated with the laundry sheet during the washing.
